(19) United States
(12) Patent Application Publication
(10) Pub. No.: US 2025/0291188 A1
(43) Pub. Date: Sep. 18, 2025

(54) COMPACT LCoS DISPLAY ENGINE FOR ARTIFICIAL REALITY

(71) Applicant: Meta Platforms Technologies, LLC, Menlo Park, CA (US)

(72) Inventor: Tamer Elazhary, Redmond, WA (US)

(21) Appl. No.: 19/069,532

(22) Filed: Mar. 4, 2025

Related U.S. Application Data
(60) Provisional application No. 63/566,528, filed on Mar. 18, 2024.

(51) Int. Cl. G02B 27/01; G02B 27/28; G02B 27/30

(52) U.S. Cl. CPC G02B 27/0172; G02B 27/0176; G02B 27/283; G02B 27/30; G02B 2027/015; G02B 2027/0152; G02B 2027/0178

(57) ABSTRACT

A display engine includes an illumination module, an LCoS display panel, a waveguide, and projection optics configured to direct source light from the illumination module to the LCoS display panel and direct image light from the LCoS display panel to the waveguide.

### CROSS-REFERENCE TO RELATED APPLICATION

This application claims the benefit of priority under 35 U.S.C. § 119(e) of U.S. Provisional Application No. 63/566,528, filed Mar. 18, 2024, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an illustration of a projection optics architecture according to various embodiments.

FIG. 2 is an illustration of a projection optics architecture without a co-integrated polarization beam splitter according to some embodiments.

FIG. 3 is an illustration of an eyepiece projection and direct-lit backlight illumination display module having a compact form factor according to certain embodiments.

FIG. 4 is an illustration of a backlight illumination module integrated with a projection optics architecture according to various embodiments.

FIG. 5 shows illustrations of a direct-lit backlight illumination configuration and an edge-lit backlight illumination configuration according to some embodiments.

FIG. 6 is an illustration of an eyepiece projection and direct-lit illumination display module according to certain embodiments.

FIG. 7 is an illustration of a birdbath projection and direct-lit illumination display module according to further embodiments.

FIG. 8 is an illustration of exemplary augmented-reality glasses that may be used in connection with embodiments of this disclosure.

FIG. 9 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Virtual reality (VR) and augmented reality (AR) eyewear devices and headsets enable users to experience events, such as interactions with people in a computer-generated simulation of a three-dimensional world or viewing data superimposed on a real-world view. Superimposing information onto a field of view may be achieved through an optical head-mounted display (OHMD) or by using embedded wireless glasses with a transparent heads-up display (HUD) or augmented reality overlay. VR/AR eyewear devices and headsets may be used for a variety of purposes. Governments may use such devices for military training, medical professionals may use such devices to simulate surgery, and engineers may use such devices as design visualization aids.

Virtual reality and augmented reality devices and headsets typically include an optical system having a microdisplay and imaging optics. Display light may be generated and projected to the eyes of a user using a display system where the light is in-coupled into a waveguide, transported therethrough by total internal reflection (TIR), replicated to form an expanded field of view, and out-coupled when reaching the position of a viewer's eye.

The microdisplay may be configured to provide an image to be viewed either directly or indirectly using, for example, a micro OLED display or by illuminating a liquid-crystal based display such as a liquid crystal on silicon (LCoS) microdisplay. Liquid crystal on silicon is a miniaturized reflective or transmissive active-matrix display having a liquid crystal layer disposed over a silicon backplane. During operation, light from a light source is directed at the liquid crystal layer and as the local orientation of the liquid crystals is modulated by a pixel-specific applied voltage, the phase retardation of the incident wavefront can be controlled to generate an image from the reflected or transmitted light. In some instantiations, a liquid crystal on silicon display may be referred to as a spatial light modulator.

LCoS-based projectors typically use three LCoS chips, one each to modulate light in the red, green, and blue channels. An LCoS projector may be configured to deliver the red, green, and blue components of image light simultaneously, which may result in a projected image having rich and well-saturated colors. As will be appreciated, an LCoS display may be configured for wavelength selective switching, structured illumination, optical pulse shaping, in addition to near-eye displays. According to further embodiments, an LCoS-based projector may include a single LCoS chip that is illuminated by red, green, and blue light sequentially.

Due at least in part to inherent high resolution and high fill factors (minimal inter-pixel spacing), visible pixelation on an LCoS machine may be essentially nonexistent resulting in a high fidelity, continuous image. Moreover, in contrast to micro-mirror based projection systems that can generate high frequencies that accentuate their digital nature, LCoS pixel edges tend to be smoother, which may give them an analog-like response resulting in a more natural image.

Notwithstanding recent developments, it would be advantageous to develop an LCoS display engine having a commercially-relevant form factor, particularly for use in portable and wearable optics such as AR glasses.

As disclosed herein, an LCoS display engine has a commercially-relevant form factor. In accordance with certain embodiments, the display engine includes an illumination module, an LCoS display panel, a waveguide, and projection optics configured to direct source light from the illumination module to the LCoS display panel and direct image light from the LCoS display panel to the waveguide. The illumination module may include a backlight module.

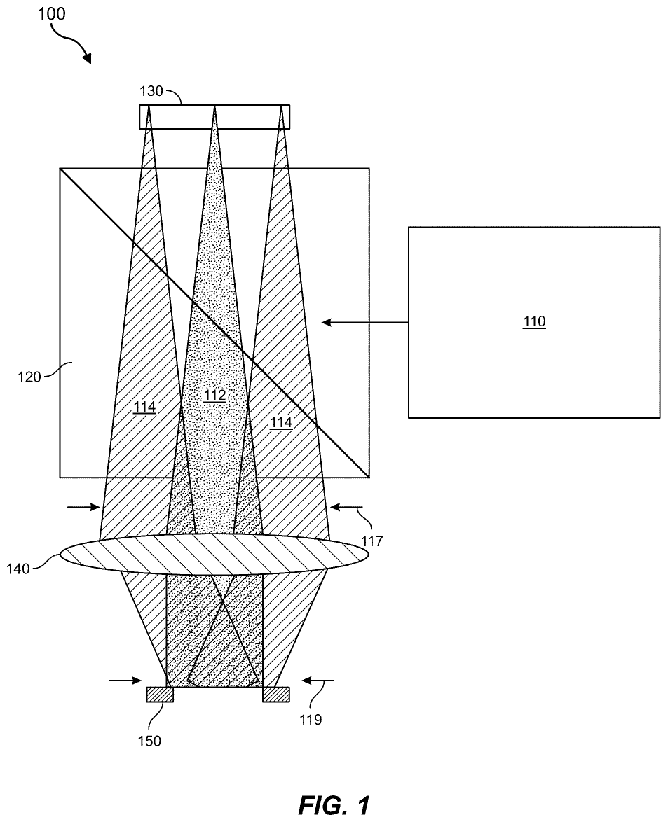

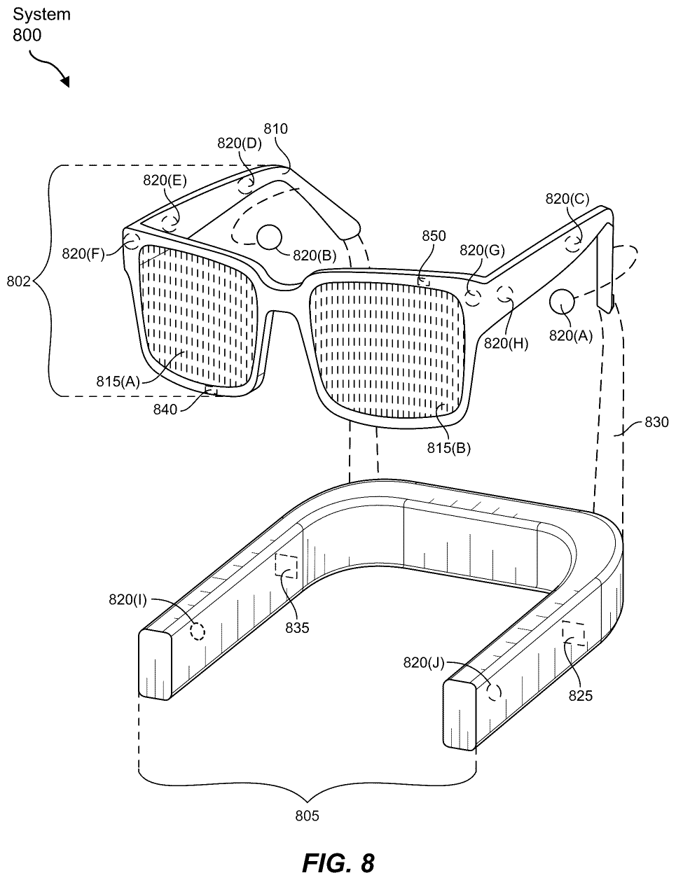

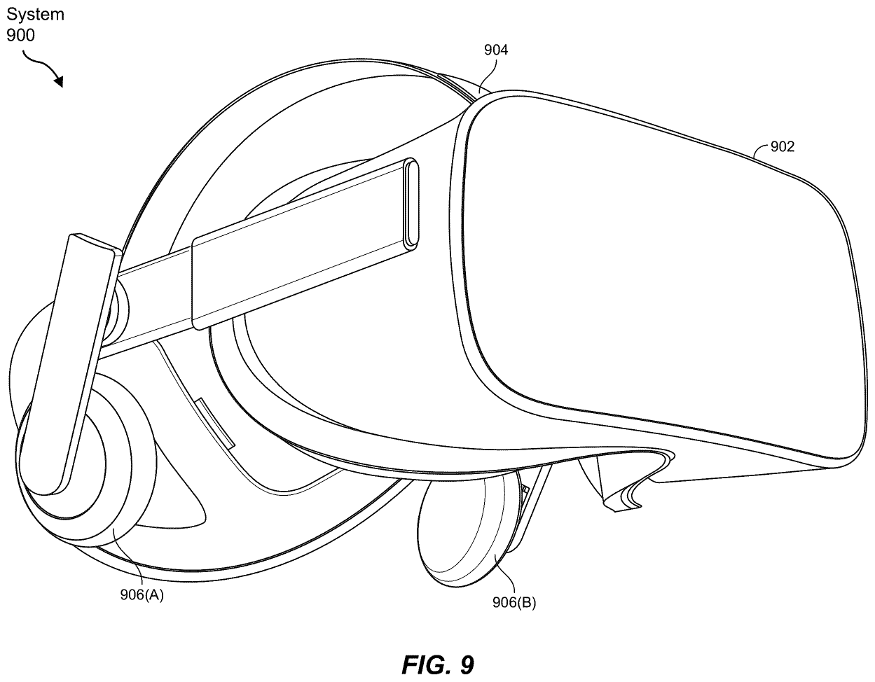

The following will provide, with reference to FIGS. 1-9, detailed descriptions of compact LCoS display engine architectures and related methods. The discussion associated with FIGS. 1-7 includes a description of example LCoS display optics having a compact form factor. The discussion associated with FIGS. 8 and 9 relates to exemplary virtual reality and augmented reality devices that may include one or more LCoS display architectures as disclosed herein.

As will be appreciated, projection optics that include a polarization beam splitter (PBS) may have an undesirably large form factor that may create challenges to their incorporation into portable and wearable optics. A comparative system is shown in FIG. 1. The system 100 includes an illumination module 110, a polarization beam splitter 120 positioned downstream of the illumination module, an LCoS panel 130, and a collimator lens 140 located between the PBS and an output aperture 150.

Example light paths through the projection optics, including an on-axis beam 112 and off-axis beams 114 are illustrated together with an upstream light footprint 117 upstream of the collimator lens 140 and a downstream light footprint 119 downstream of the collimator lens 140.

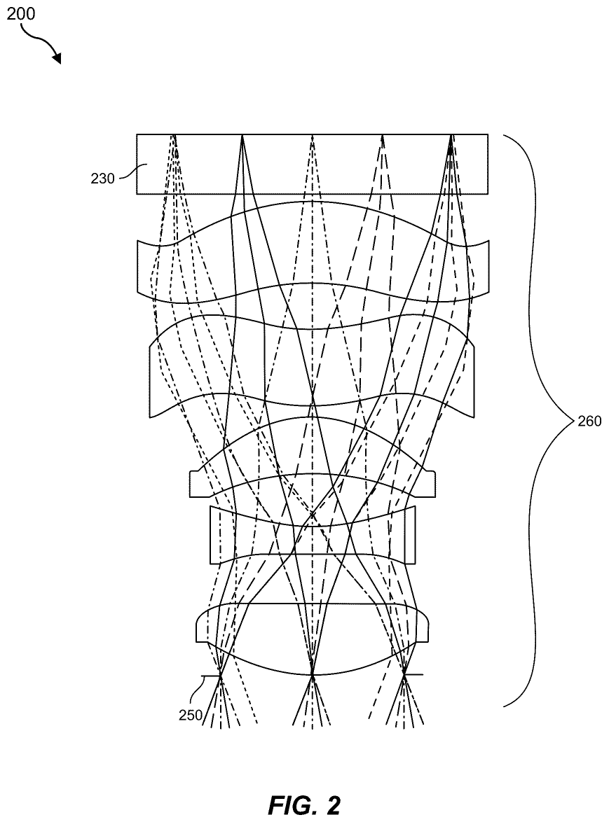

In accordance with various embodiments, a projection optic architecture where the PBS has been eliminated is shown in FIG. 2. In the illustrated system 200, light propagates between an LCoS panel 230 and an output aperture 250 via a plurality of lenses 260 (i.e., a lens bundle). The absence of a polarization beam splitter allows beams of image light to overlap across the field of view. As shown schematically in FIG. 2, the areal dimensions of the lens optics may be comparable to the LCoS panel dimensions and/or the output aperture dimensions.

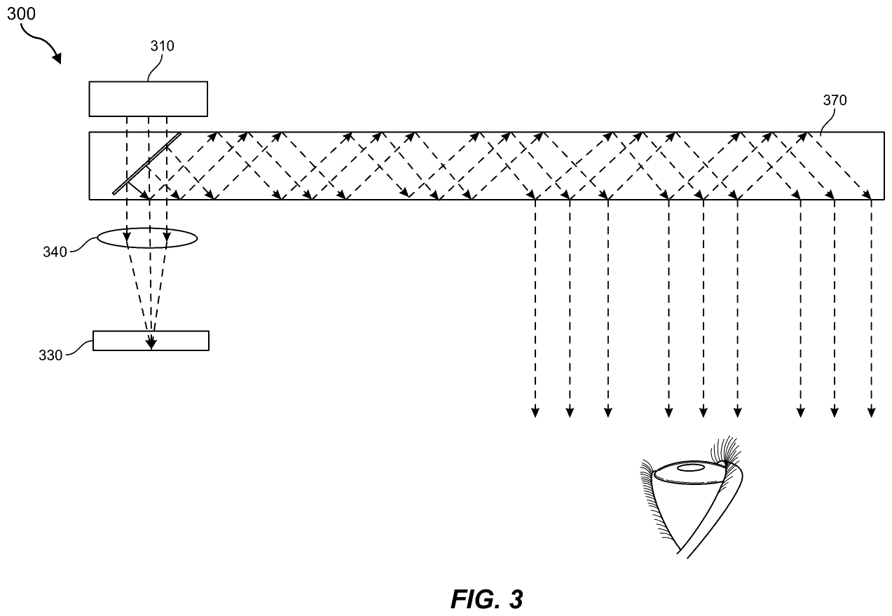

Referring to FIG. 3, shown schematically is a cross-sectional view of an example LCoS display engine having a compact form factor. In the system 300 of FIG. 3, eyepiece projection optics, including a collimator lens 340 and a LCoS panel 330, and a direct-lit backlight illumination module 310 may be positioned on opposite sides of a waveguide 370. The display engine may be configured such that light illuminating each pixel is a summation of all LED contributions from the illumination module 310, which may improve image uniformity. The footprint of system 300 may be substantially smaller than the footprint of comparative LCoS projector-based systems.

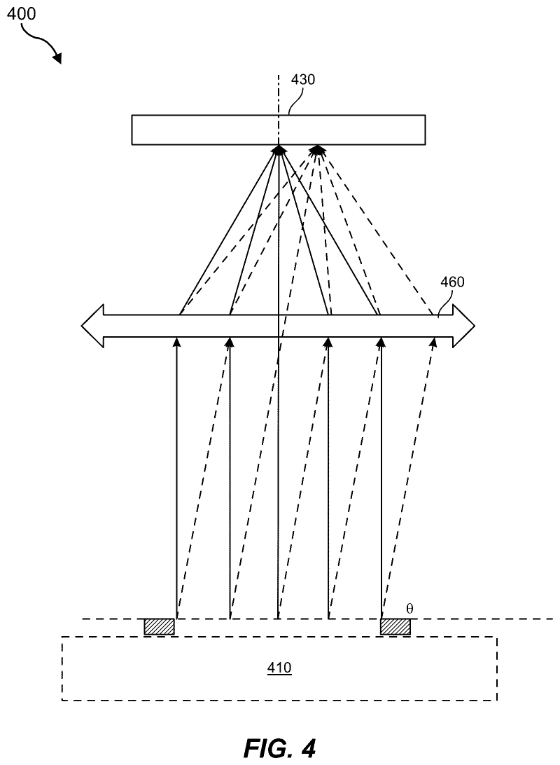

A complementary architecture having an illumination module and an LCoS panel arranged on opposite sides of projection optics (i.e., a lens bundle) is shown in FIG. 4. In system 400, image light may emanate from a backlight illumination module 410 whereafter it is focused onto an LCoS panel 430 by projection optics 460. Projection optics 460 may include a plurality of stacked lenses, for example. Each pixel on the LCoS panel may be illuminated by light rays that emanate from the illumination module along a pixel-specific direction across the entire aperture, which may improve the overall uniformity of the light reaching the LCoS panel 430. That is, a first pixel within the LCoS panel may be illuminated by a plurality of on-axis rays, whereas a second pixel within the LCoS panel may be illuminated by a plurality of off-axis rays emanating at a given angle (0).

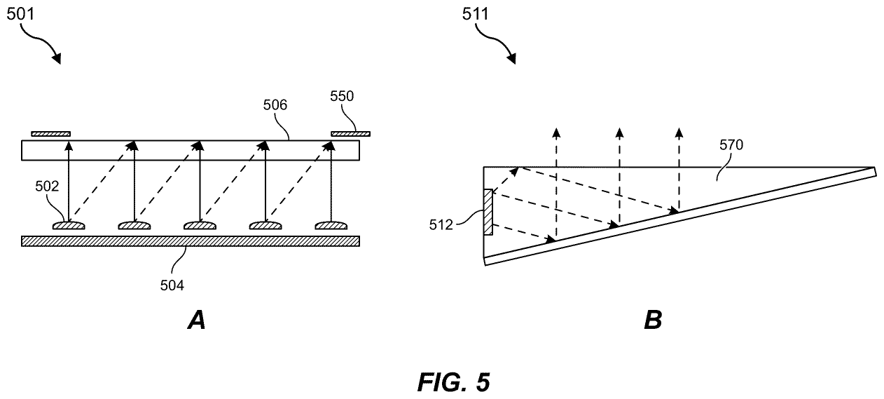

Exemplary illumination module configurations are shown in FIG. 5. The generalized architectures of direct-lit and edge-lit illumination modules are depicted in FIG. 5A and FIG. 5B, respectively. The direct-lit backlight module 501 of FIG. 5A may include an array of LEDs 502 sandwiched between a reflector 504 and a diffuser plate 506. Direct-lit module 501 may be configured to project uniform light output through exit aperture 550. The edge-lit module 511 of FIG. 5B may include one or more light emitting diodes 512 located at the edge of a non-planar (e.g., wedge-shaped) waveguide 570. A uniform distribution of light may be generated by reflections between upper and lower surfaces of the waveguide 570 before the light is outcoupled toward a projector lens (not shown).

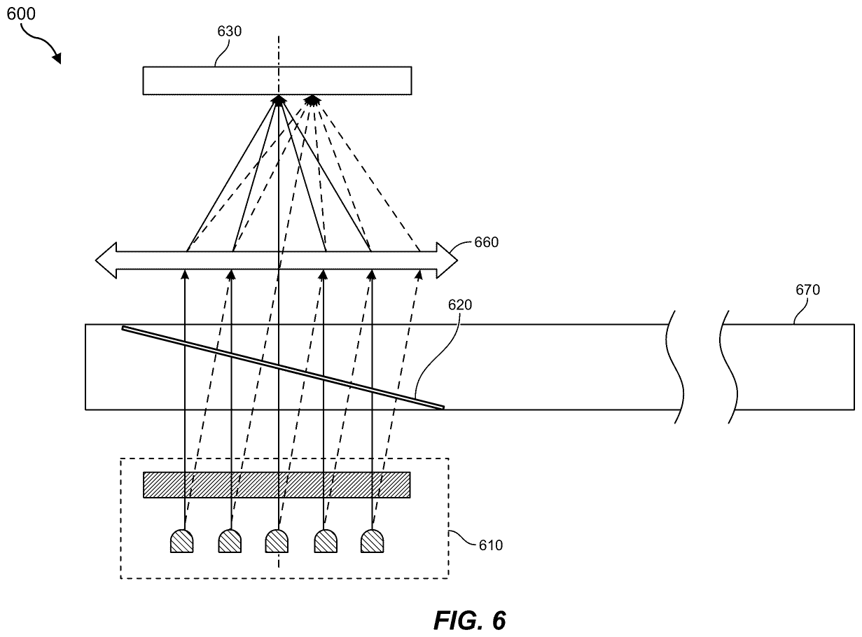

Referring to FIG. 6, shown is a schematic illustration of a further LCoS display engine having a compact form factor. During operation of system 600, light emanating from an illumination module 610 may be focused by projection optics 660 onto an LCoS panel 630 whereafter the light is re-directed through the projection optics 660 and in-coupled into a waveguide 670. In the illustrated embodiment, the illumination module 610 and the LCoS panel 630 are located on opposite sides of the waveguide 670. In some embodiments, a polarization beam splitter 620 may be co-integrated within the waveguide 670. The illumination module 610 may include a direct-lit or edge-lit illumination module, for example.

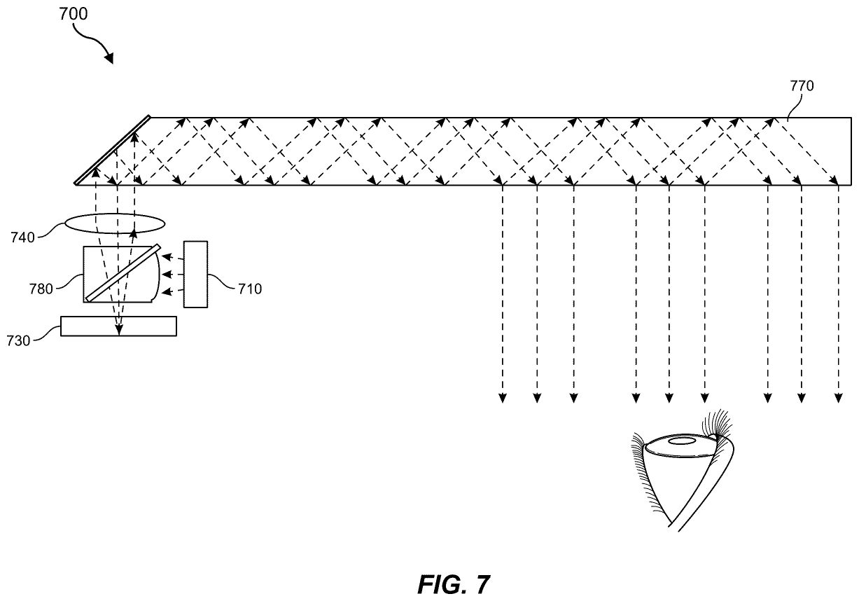

A still further display engine architecture having a compact form factor is shown schematically in FIG. 7. System 700 includes a direct-lit back light illumination module 710 and a birdbath projector 780 optically aligned with the illumination module 710. Light from the illumination module 710 may be directed toward LCoS panel 730 and then through collimator lens 740 to a planar waveguide 770. In the FIG. 7 architecture, the illumination module 710 and the birdbath projector 780 are co-integrated on one side of the projection optics.

### Example Embodiments

Example 1: A display engine includes an illumination module, an LCoS display panel, a waveguide, and projection optics configured to direct source light from the illumination module to the LCoS display panel and direct image light from the LCoS display panel to the waveguide.

Example 2: The display engine of Example 1, where the illumination module is a direct-lit module.

Example 3: The display engine of Example 1, where the illumination mobile is an edge-lit module.

Example 4: The display engine of any of Examples 1-3, where the illumination module is a backlight module.

Example 5: The display engine of any of Examples 1-4, where the illumination module includes a polarization recycling element.

Example 6: The display engine of any of Examples 1-5, where the illumination module includes and the LCoS display panel are located on opposite sides of the waveguide.

Example 7: The display engine of any of Examples 1-6, where the illumination module includes and the LCoS display panel are located on a common side of the waveguide.

Example 8: The display engine of any of Examples 1-7, further including a polarization beam splitter located within the waveguide.

Example 9: The display engine of any of Examples 1-8, where the projection optics includes a polarization beam splitter.

Example 10: The display engine of any of Examples 1-6, further including a collimator located between the LCoS display panel and the waveguide.

Example 11: A display engine includes a backlight illumination module, an LCoS display panel, a waveguide, a collimator located between the LCoS display panel and the waveguide, and projection optics configured to direct source light from the illumination module to the LCoS display panel and direct image light from the LCoS display panel through the collimator to the waveguide.

Example 12: The display engine of Example 11, where the illumination module is a direct-lit module.

Example 13: The display engine of Example 11, where the illumination mobile is an edge-lit module.

Example 14: The display engine of any of Examples 11-13, where the illumination mobile includes a polarization recycling element.

Example 15: The display engine of any of Examples 11-14, where the illumination module and the LCoS display panel are located on opposite sides of the waveguide.

Example 16: The display engine of any of Examples 11-14, where the illumination module and the LCoS display panel are located on a common side of the waveguide.

Example 17: The display engine of any of Examples 11-16, where a polarization beam splitter is located within the waveguide.

Example 18: The display engine of any of Examples 11-17, where the projection optics includes a polarization beam splitter.

Example 19: A display engine includes an illumination module including at least one light emitting diode, an LCoS display panel arranged to receive source light output by the illumination module, a waveguide arranged to receive image light emitted from the LCoS display panel, and projection optics configured to direct the source light from the illumination module to the LCoS display panel and direct the image light from the LCoS display panel to the waveguide.

Example 20: The display engine of Example 19, further including a collimator located between the LCoS display panel and the waveguide.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 800 in FIG. 8) or that visually immerses a user in an artificial reality (e.g., virtual-reality system 900 in FIG. 9). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 8, augmented-reality system 800 may include an eyewear device 802 with a frame 810 configured to hold a left display device 815(A) and a right display device 815(B) in front of a user's eyes. Display devices 815(A) and 815(B) may act together or independently to present an image or series of images to a user. While augmented-reality system 800 includes two displays, embodiments of this disclosure may be implemented in augmented-reality systems with a single NED or more than two NEDs.

In some embodiments, augmented-reality system 800 may include one or more sensors, such as sensor 840. Sensor 840 may generate measurement signals in response to motion of augmented-reality system 800 and may be located on substantially any portion of frame 810. Sensor 840 may represent a position sensor, an inertial measurement unit (IMU), a depth camera assembly, a structured light emitter and/or detector, or any combination thereof. In some embodiments, augmented-reality system 800 may or may not include sensor 840 or may include more than one sensor. In embodiments in which sensor 840 includes an IMU, the IMU may generate calibration data based on measurement signals from sensor 840. Examples of sensor 840 may include, without limitation, accelerometers, gyroscopes, magnetometers, other suitable types of sensors that detect motion, sensors used for error correction of the IMU, or some combination thereof.

Augmented-reality system 800 may also include a microphone array with a plurality of acoustic transducers 820(A)-820(J), referred to collectively as acoustic transducers 820. Acoustic transducers 820 may be transducers that detect air pressure variations induced by sound waves. Each acoustic transducer 820 may be configured to detect sound and convert the detected sound into an electronic format (e.g., an analog or digital format). The microphone array in FIG. 8 may include, for example, ten acoustic transducers: 820(A) and 820(B), which may be designed to be placed inside a corresponding ear of the user, acoustic transducers 820(C), 820(D), 820(E), 820(F), 820(G), and 820(H), which may be positioned at various locations on frame 810, and/or acoustic transducers 820(I) and 820(J), which may be positioned on a corresponding neckband 805.

In some embodiments, one or more of acoustic transducers 820(A)-(F) may be used as output transducers (e.g., speakers). For example, acoustic transducers 820(A) and/or 820(B) may be earbuds or any other suitable type of headphone or speaker.

The configuration of acoustic transducers 820 of the microphone array may vary. While augmented-reality system 800 is shown in FIG. 8 as having ten acoustic transducers 820, the number of acoustic transducers 820 may be greater or less than ten. In some embodiments, using higher numbers of acoustic transducers 820 may increase the amount of audio information collected and/or the sensitivity and accuracy of the audio information. In contrast, using a lower number of acoustic transducers 820 may decrease the computing power required by an associated controller 850 to process the collected audio information. In addition, the position of each acoustic transducer 820 of the microphone array may vary. For example, the position of an acoustic transducer 820 may include a defined position on the user, a defined coordinate on frame 810, an orientation associated with each acoustic transducer 820, or some combination thereof.

Acoustic transducers 820(A) and 820(B) may be positioned on different parts of the user's ear, such as behind the pinna, behind the tragus, and/or within the auricle or fossa. Or, there may be additional acoustic transducers 820 on or surrounding the ear in addition to acoustic transducers 820 inside the ear canal. Having an acoustic transducer 820 positioned next to an ear canal of a user may enable the microphone array to collect information on how sounds arrive at the ear canal. By positioning at least two of acoustic transducers 820 on either side of a user's head (e.g., as binaural microphones), augmented-reality device 800 may simulate binaural hearing and capture a 3D stereo sound field around about a user's head. In some embodiments, acoustic transducers 820(A) and 820(B) may be connected to augmented-reality system 800 via a wired connection 830, and in other embodiments acoustic transducers 820(A) and 820(B) may be connected to augmented-reality system 800 via a wireless connection (e.g., a Bluetooth connection). In still other embodiments, acoustic transducers 820(A) and 820(B) may not be used at all in conjunction with augmented-reality system 800.

Acoustic transducers 820 on frame 810 may be positioned along the length of the temples, across the bridge, above or below display devices 815(A) and 815(B), or some combination thereof. Acoustic transducers 820 may be oriented such that the microphone array is able to detect sounds in a wide range of directions surrounding the user wearing the augmented-reality system 800. In some embodiments, an optimization process may be performed during manufacturing of augmented-reality system 800 to determine relative positioning of each acoustic transducer 820 in the microphone array.

In some examples, augmented-reality system 800 may include or be connected to an external device (e.g., a paired device), such as neckband 805. Neckband 805 generally represents any type or form of paired device. Thus, the following discussion of neckband 805 may also apply to various other paired devices, such as charging cases, smart watches, smart phones, wrist bands, other wearable devices, hand-held controllers, tablet computers, laptop computers, other external compute devices, etc.

As shown, neckband 805 may be coupled to eyewear device 802 via one or more connectors. The connectors may be wired or wireless and may include electrical and/or non-electrical (e.g., structural) components. In some cases, eyewear device 802 and neckband 805 may operate independently without any wired or wireless connection between them. While FIG. 8 illustrates the components of eyewear device 802 and neckband 805 in example locations on eyewear device 802 and neckband 805, the components may be located elsewhere and/or distributed differently on eyewear device 802 and/or neckband 805. In some embodiments, the components of eyewear device 802 and neckband 805 may be located on one or more additional peripheral devices paired with eyewear device 802, neckband 805, or some combination thereof.

Pairing external devices, such as neckband 805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 800 may be provided by a paired device or shared between a paired device and an eyewear device, thus reducing the weight, heat profile, and form factor of the eyewear device overall while still retaining desired functionality. For example, neckband 805 may allow components that would otherwise be included on an eyewear device to be included in neckband 805 since users may tolerate a heavier weight load on their shoulders than they would tolerate on their heads. Neckband 805 may also have a larger surface area over which to diffuse and disperse heat to the ambient environment. Thus, neckband 805 may allow for greater battery and computation capacity than might otherwise have been possible on a stand-alone eyewear device. Since weight carried in neckband 805 may be less invasive to a user than weight carried in eyewear device 802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 805 may be communicatively coupled with eyewear device 802 and/or to other devices. These other devices may provide certain functions (e.g., tracking, localizing, depth mapping, processing, storage, etc.) to augmented-reality system 800. In the embodiment of FIG. 8, neckband 805 may include two acoustic transducers (e.g., 820(I) and 820(J)) that are part of the microphone array (or potentially form their own microphone subarray). Neckband 805 may also include a controller 825 and a power source 835.

Acoustic transducers 820(I) and 820(J) of neckband 805 may be configured to detect sound and convert the detected sound into an electronic format (analog or digital). In the embodiment of FIG. 8, acoustic transducers 820(I) and 820(J) may be positioned on neckband 805, thereby increasing the distance between the neckband acoustic transducers 820(I) and 820(J) and other acoustic transducers 820 positioned on eyewear device 802. In some cases, increasing the distance between acoustic transducers 820 of the microphone array may improve the accuracy of beamforming performed via the microphone array. For example, if a sound is detected by acoustic transducers 820(C) and 820(D) and the distance between acoustic transducers 820(C) and 820(D) is greater than, e.g., the distance between acoustic transducers 820(D) and 820(E), the determined source location of the detected sound may be more accurate than if the sound had been detected by acoustic transducers 820(D) and 820(E).

Controller 825 of neckband 805 may process information generated by the sensors on neckband 805 and/or augmented-reality system 800. For example, controller 825 may process information from the microphone array that describes sounds detected by the microphone array. For each detected sound, controller 825 may perform a direction-of-arrival (DOA) estimation to estimate a direction from which the detected sound arrived at the microphone array. As the microphone array detects sounds, controller 825 may populate an audio data set with the information. In embodiments in which augmented-reality system 800 includes an inertial measurement unit, controller 825 may compute all inertial and spatial calculations from the IMU located on eyewear device 802. A connector may convey information between augmented-reality system 800 and neckband 805 and between augmented-reality system 800 and controller 825. The information may be in the form of optical data, electrical data, wireless data, or any other transmittable data form. Moving the processing of information generated by augmented reality system 800 to neckband 805 may reduce weight and heat in eyewear device 802, making it more comfortable to the user.

Power source 835 in neckband 805 may provide power to eyewear device 802 and/or to neckband 805. Power source 835 may include, without limitation, lithium ion batteries, lithium-polymer batteries, primary lithium batteries, alkaline batteries, or any other form of power storage. In some cases, power source 835 may be a wired power source. Including power source 835 on neckband 805 instead of on eyewear device 802 may help better distribute the weight and heat generated by power source 835.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 900 in FIG. 9, that mostly or completely covers a user's field of view. Virtual-reality system 900 may include a front rigid body 902 and a band 904 shaped to fit around a user's head. Virtual-reality system 900 may also include output audio transducers 906(A) and 906(B). Furthermore, while not shown in FIG. 9, front rigid body 902 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 800 and/or virtual-reality system 900 may include one or more liquid crystal displays (LCDs), light emitting diode (LED) displays (e.g., micro LEDs), organic LED (OLED) displays (e.g., micro OLEDs), digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 800 and/or virtual-reality system 900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 800 and/or virtual-reality system 900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 9, output audio transducers 906(A) and 906(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 8, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a lens that comprises or includes polycarbonate include embodiments where a lens consists essentially of polycarbonate and embodiments where a lens consists of polycarbonate.

What is claimed is:

1. A display engine comprising:
an illumination module;
an LCoS display panel;
a waveguide; and
projection optics configured to direct source light from the illumination module to the LCoS display panel and direct image light from the LCoS display panel to the waveguide.

2. The display engine of claim 1, wherein the illumination module comprises a direct-lit module.

3. The display engine of claim 1, wherein the illumination module comprises an edge-lit module.

4. The display engine of claim 1, wherein the illumination module comprises a backlight module.

5. The display engine of claim 1, wherein the illumination module comprises a polarization recycling element.

6. The display engine of claim 1, wherein the illumination module and the LCoS display panel are located on opposite sides of the waveguide.

7. The display engine of claim 1, wherein the illumination module and the LCoS display panel are located on a common side of the waveguide.

8. The display engine of claim 1, wherein the waveguide comprises a polarization beam splitter located within the waveguide.

9. The display engine of claim 1, wherein the projection optics comprises a polarization beam splitter.

10. The display engine of claim 1, further comprising a collimator located between the LCoS display panel and the waveguide.

11. A display engine comprising:
a backlight illumination module;
an LCoS display panel;
a waveguide;
a collimator located between the LCoS display panel and the waveguide; and
projection optics configured to direct source light from the illumination module to the LCoS display panel and direct image light from the LCoS display panel through the collimator to the waveguide.

12. The display engine of claim 11, wherein the illumination module comprises a direct-lit module.

13. The display engine of claim 11, wherein the illumination module comprises an edge-lit module.

14. The display engine of claim 11, wherein the illumination module comprises a polarization recycling element.

15. The display engine of claim 11, wherein the illumination module and the LCoS display panel are located on opposite sides of the waveguide.

16. The display engine of claim 11, wherein the illumination module and the LCoS display panel are located on a common side of the waveguide.

17. The display engine of claim 11, wherein the waveguide comprises a polarization beam splitter located within the waveguide.

18. The display engine of claim 11, wherein the projection optics comprises a polarization beam splitter.

19. A display engine comprising:
an illumination module comprising at least one light emitting diode;
an LCoS display panel arranged to receive source light output by the illumination module;
a waveguide arranged to receive image light emitted from the LCoS display panel; and
projection optics configured to direct the source light from the illumination module to the LCoS display panel and direct the image light from the LCoS display panel to the waveguide.

20. The display engine of claim 19, further comprising a collimator located between the LCoS display panel and the waveguide.
